(19) United States
(12) Patent Application Publication
(10) Pub. No.: US 2012/0081393 A1
(43) Pub. Date: Apr. 5, 2012

(54) APPARATUS AND METHOD FOR PROVIDING AUGMENTED REALITY USING VIRTUAL OBJECTS

(75) Inventor: Bo-Sun KIM, Seoul (KR)

(73) Assignee: PANTECH CO., LTD., Seoul (KR)

(21) Appl. No.: 13/197,483

(22) Filed: Aug. 3, 2011

(30) Foreign Application Priority Data
Sep. 30, 2010 (KR) 10-2010-0095576

(51) Int. Cl. G09G 5/00

(52) U.S. Cl. 345/633

(57) ABSTRACT

A method for providing AR information, in which the method includes receiving virtual object setting information by a first terminal, in which the virtual object setting information including virtual object selection information and movement setting information; and transmitting a request to a server for uploading a virtual object onto a real-world image of a target location based on the virtual object setting information. An apparatus to provide AR information, in which the apparatus includes a communication unit to process signals received from a server and to transmit signals to the server; a display unit to display a real-world image of a target location; a manipulation unit to receive a user input signal; and a control unit to receive virtual object setting information and to request the server to upload a virtual object onto the real-world image of the target location.

### CROSS-REFERENCE TO RELATED APPLICATION(S)

This application claims priority from and the benefit under 35 U.S.C. §119(a) of Korean Patent Application No. 10-2010-0095576, filed on Sep. 30, 2010, which is incorporated by reference for all purposes as if fully set forth herein.

### BACKGROUND

1. Field

The following description relates to an apparatus and method for providing augmented reality (AR) information, and more particularly to an apparatus and method for providing AR information using virtual objects.

2. Discussion of the Background

Augmented reality (AR) is a computer graphics technology that combines an image of a physical real-world environment with virtual objects or information. AR, unlike virtual reality (VR) that is primarily based on virtual spaces and virtual objects, synthesizes virtual objects with an image of the real world or a real-world image to provide additional information that may not be easily obtained in the real world. Thus, AR, unlike VR having a limited range of application, can be applied to various real-world environments, and has attracted public attention as a suitable next-generation display technologies for ubiquitous environments.

AR services provide the ability for users to interact with virtual objects. However, no methods have been suggested for enabling interactions between multiple users in AR.

### SUMMARY

Exemplary embodiments of the present invention provide an apparatus and method for providing augmented reality (AR) information using virtual objects.

Additional features of the invention will be set forth in the description which follows, and in part will be apparent from the description, or may be learned by practice of the invention.

Exemplary embodiments of the present invention provide a method for providing AR information using virtual objects, the method including receiving virtual object setting information by a first terminal, in which the virtual object setting information including virtual object selection information and movement setting information; and transmitting a request to a server for uploading a virtual object onto a real-world image of a target location based on the virtual object setting information.

Exemplary embodiments of the present invention provide a method for providing AR information using virtual objects, the method including receiving, by a server, a request signal for uploading a virtual object onto a real-world image of a target location from a terminal; receiving virtual object setting information from the terminal; and uploading a virtual object onto the real-world image based on the virtual object setting information.

Exemplary embodiments of the present invention provide an apparatus to provide AR information using virtual objects, the apparatus including a communication unit to process signals received from a server and to transmit signals to the server, in which the signals are transmitted and received using a wired and/or wireless communication network; a display unit to display a real-world image of a target location; a manipulation unit to receive a user input signal; and a control unit to receive virtual object setting information and to request the server to upload a virtual object onto the real-world image of the target location, in which the virtual object setting information including virtual object selection information and movement setting information.

Exemplary embodiments of the present invention provide an apparatus to provide AR information using virtual objects, the apparatus including a communication unit to process signals received from a terminal or to transmit signals to the terminal, in which the signals are transmitted or received using a wired and/or wireless communication network, and to receive virtual object setting information from the terminal; a virtual object information storage unit to store the virtual object setting information; and a control unit to receive a request signal to upload a virtual object onto a real-world image of a target location, and to control the virtual object information storage unit to store the virtual object setting information upon the receipt of the request signal.

It is to be understood that both the foregoing general description and the following detailed description are exemplary and explanatory and are intended to provide further explanation of the invention as claimed. Other features and aspects may be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a communication system to provide augmented reality (AR) information using virtual objects according to an exemplary embodiment of the invention.

FIG. 2 is a diagram illustrating a terminal to provide AR information using virtual objects according to an exemplary embodiment of the invention.

FIG. 3 is a diagram illustrating a server to provide AR information using virtual objects according to an exemplary embodiment of the invention.

FIG. 4 is a flowchart illustrating a method of providing AR information using virtual objects according to an exemplary embodiment of the invention.

FIG. 5A is a diagram illustrating a ‘set virtual object’ menu screen according to an exemplary embodiment of the invention.

FIG. 5B is a diagram illustrating an interface screen to set a path for a virtual object to move along according to an exemplary embodiment of the invention.

FIG. 6 is a flowchart illustrating a method of providing AR information using virtual objects according to an exemplary embodiment of the invention.

FIG. 7 is a diagram illustrating a virtual object superimposed over a real-world according to an exemplary embodiment of the invention.

FIG. 8 is a diagram illustrating a display screen that can be displayed during a communication service between terminals using virtual objects according to an exemplary embodiment of the invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ). Throughout the drawings and the detailed description, unless otherwise described, the same drawing reference numerals are understood to refer to the same elements, features, and structures. The relative size and depiction of these elements may be exaggerated for clarity, illustration, and convenience.

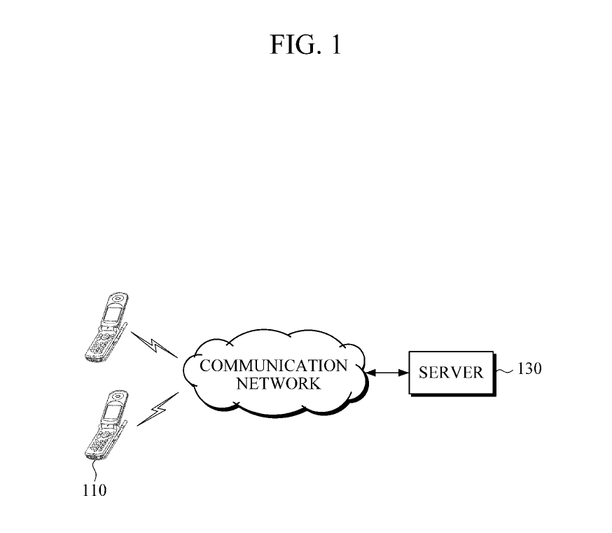

FIG. 1 is a diagram illustrating a communication system to provide augmented is reality (AR) information using virtual objects according to an exemplary embodiment of the invention.

Referring to FIG. 1, the communication system may include one or more apparatuses 110 (hereinafter referred to as terminals 110) and a server 130 to provide AR information using virtual objects. The terminals 110 and the server 130 may be connected to a wired and/or wireless communication network.

In an example, terminals 110 may include mobile communication terminals, personal computers and devices that are able to register various virtual objects and display the virtual objects over an image of a real physical world or a real-world image. Mobile communication terminals may include, without limitation, personal digital assistants (PDAs), smart phones, tablet computers, and navigation devices. Personal computers may include, without limitation, desktops and laptops.

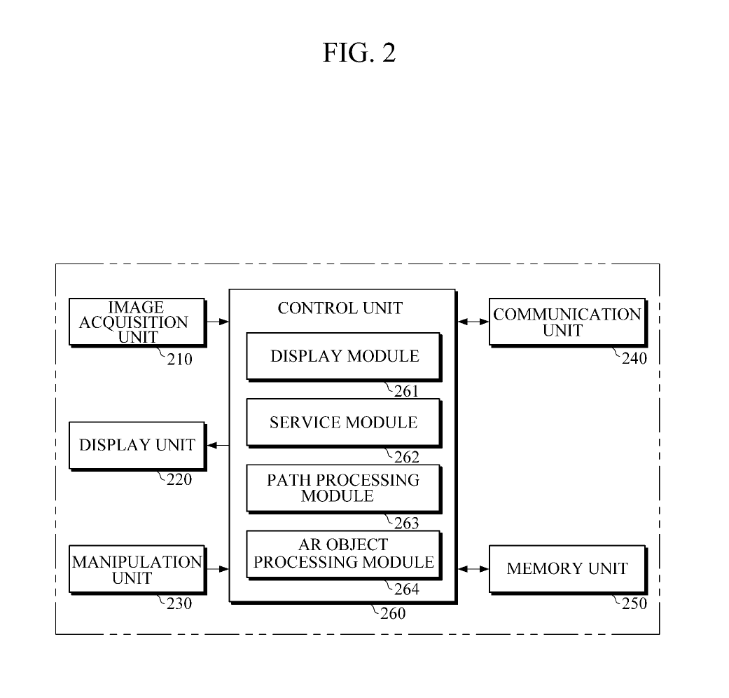

FIG. 2 is a diagram illustrating a terminal to provide AR information using virtual objects according to an exemplary embodiment of the invention.

Referring to FIG. 2, the terminal 110 may include an image acquisition unit 210, a display unit 220, a manipulation unit 230, a communication unit 240, a memory unit 250 and a control unit 260.

The image acquisition unit 210 may acquire an image of a real physical world or a real-world image, and may then output the acquired image to the control unit 260. In an example, the image acquisition unit 210 may be a camera or an image sensor. The image acquisition unit 210 may be a camera capable of zooming in or out under the control of the control unit 260. In addition, the image acquisition unit 210 may be a camera capable of rotating, automatically or manually, or of rotating images, automatically or manually, under the is control of the control unit 260.

The display unit 220 may output an image input to the terminal 110. More specifically, the display unit 220 may output at least one of an image of a target place, a virtual object settings screen, and social network service (SNS) information. The target place image may be provided by the image acquisition unit 210 or by the server 130 or other external device, which may be transmitted through the communication unit 240.

The manipulation unit 230 may receive user inputted information. In an example, the manipulation unit 230 may be a user interface (UI) unit, which may include a key input unit to generate key information if one or more key buttons are pressed, a touch sensor and a mouse. The manipulation unit 230 may receive at least one of a signal to request a real-world image of a target place, virtual object setting information, and a signal to request communication with a virtual object representing another user. The target place image may be provided in real-time or as a static image, which may be updated at reference intervals.

In an example, the virtual object setting information may include virtual object selection information, movement setting information, and a shape or shape setting information of a virtual object. The virtual object selection information may refer to a selection of a virtual object corresponding to the respective terminal, registration of a virtual object or the like. The movement setting information may refer to a travel path for the virtual object, which may include a point of departure, destination, travel path, moving speed, time or duration, and the like. The shape or shape information of a virtual object may refer to various shape information related to the virtual object.

The communication unit 240 may process the received input signals via a communication network and output the processed signals to the control unit 260. The is communication unit 240 may also process output signals of the control unit 260 and transmit the processed output signals to the communication network. The communication network may be a wired and/or wireless network.

The memory unit 250 may store one or more real-world images downloaded from the server 130, or other device, and one or more application programs to provide AR information. The memory unit 250 may include a flash memory or other suitable memory to store information.

The control unit 260 may control the image acquisition unit 210, the display unit 220, the manipulation unit 230, the communication unit 240 and the memory unit 250 to provide AR information using virtual objects. In an example, the control unit 260 may be implemented as a hardware processor or as a software module in a hardware processor.

The control unit 260 may include a display module 261, a service module 262, a path processing module 263, and an AR object processing module 264.

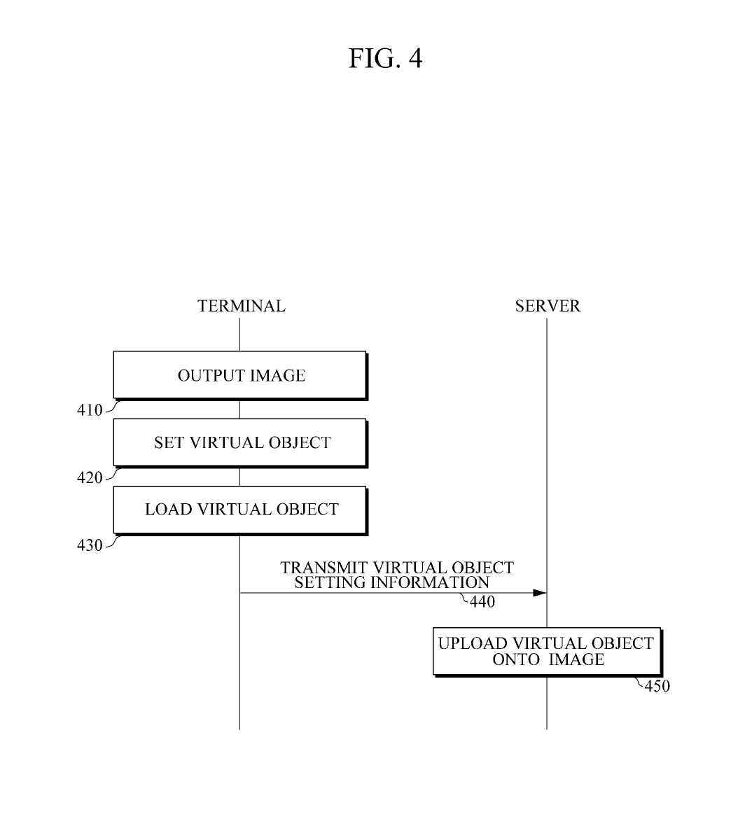

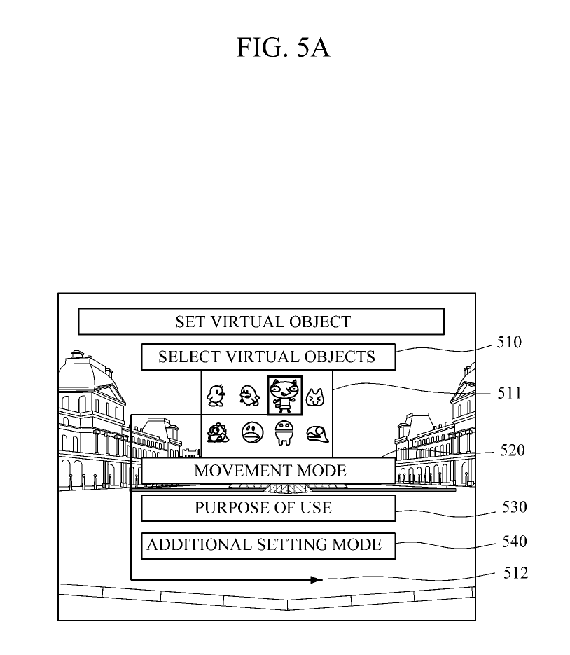

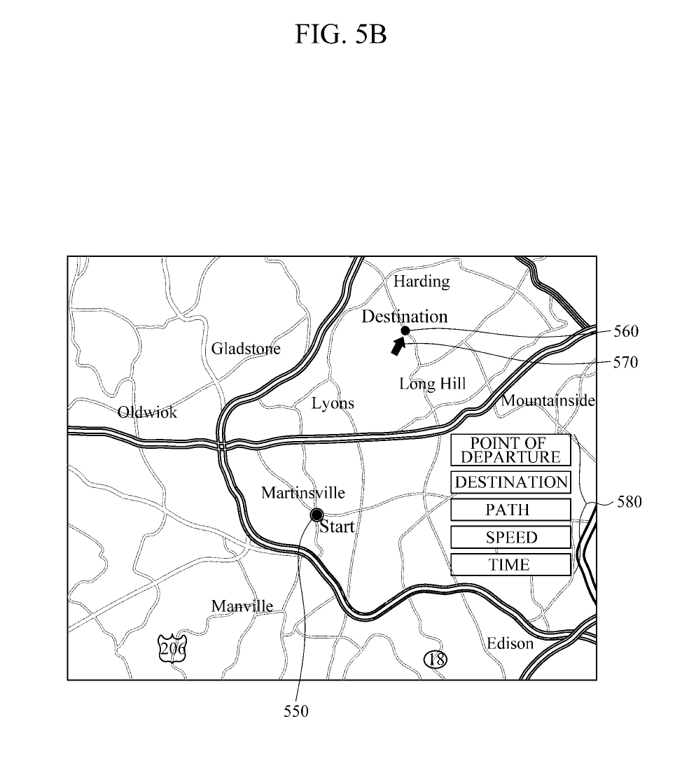

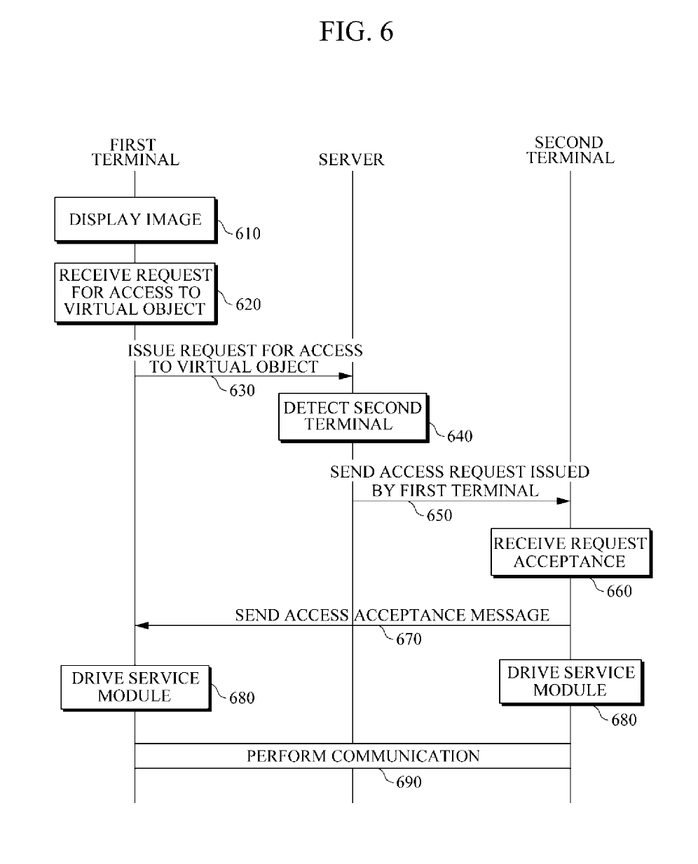

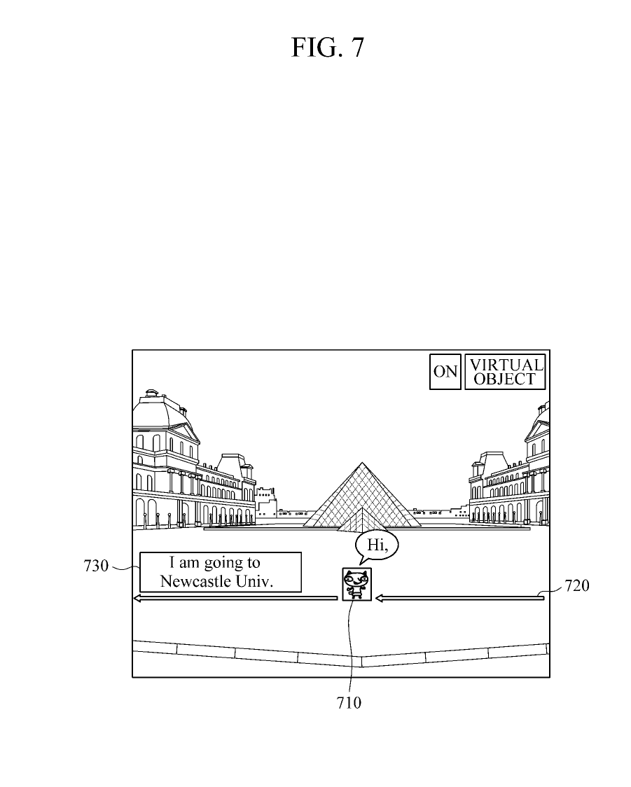

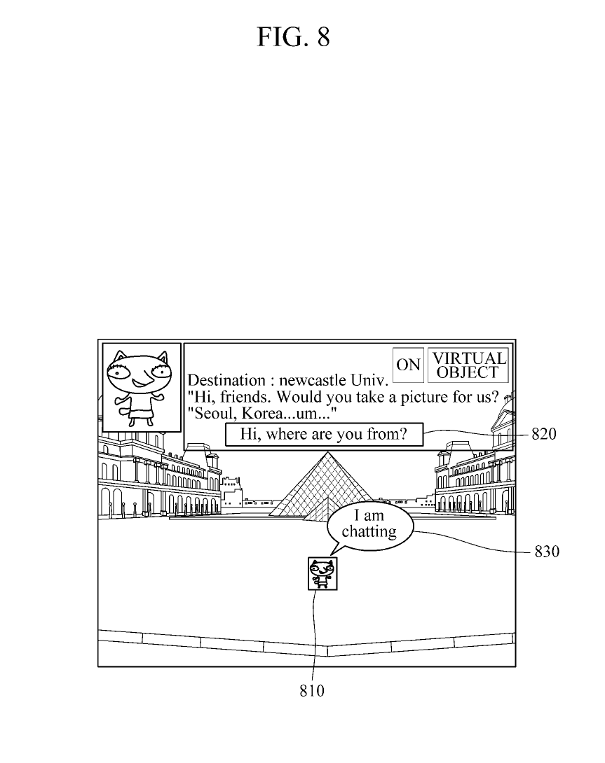

The display module 261 may be an application processor, which outputs a camera preview image combined with virtual objects on the display unit 220. The service module 262 may process various events, such as a chat or messaging session that may occur if the user is connected to another user. The path processing module 263 may set a path for one or more virtual objects loaded by the user and transmit data relevant to the path. The AR object processing module 264 may superimpose the loaded virtual objects over a real-world image acquired by the image acquisition unit 210. The operation of the control unit 260 will be described later in further detail with reference to FIG. 4, FIG. 5, FIG. 6, FIG. 7, and FIG. 8.

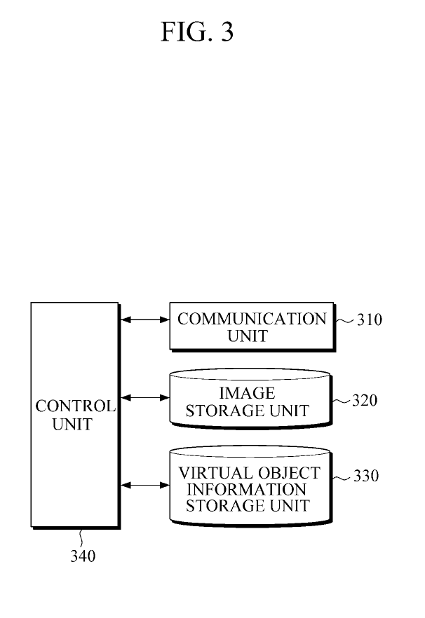

FIG. 3 is a diagram illustrating a server to provide AR information using virtual objects according to an exemplary embodiment of the invention.

Referring to FIG. 3, the server 130 may include a communication unit 310, an image storage unit 320, a virtual object information storage unit 330 and a control unit 340.

The communication unit 310 may process one or more received signals via a wired and/or wireless communication network and output the processed signals to the control unit 340.

The image storage unit 320 may store real-world image data of one or more locations. In an example, real-world image data may include images provided by cameras installed at various public places. The control unit 340 may acquire camera images of various places through the wired and/or wireless communication network and may then update the image storage unit 320 with the acquired camera images. In addition, the image storage unit 320 may be updated in real time or in a batch process with the acquired images.

The virtual object information storage unit 330 may store information on one or more virtual objects registered in the terminal 110 by the user. In an example, stored information may include identification information of a terminal 110, path information, moving speed information, SNS information on one or more virtual objects, and output phrase information specifying one or more phrases to be output in connection with one or more virtual objects. Further, the virtual object information storage unit 330 may store information on virtual objects registered in other terminals, external to the terminal 110.

The control unit 340 may control the communication unit 310, the image storage unit 320, and the virtual object information storage unit 330 to provide AR information using virtual objects. The control unit 340 may be implemented as a hardware process or a software module in a hardware processor. The operation of the control unit 340 will be described later in further detail with reference to FIG. 4, FIG. 5, FIG. 6, FIG. 7 and FIG. 8.

It will hereinafter be described examples of how to provide AR information using virtual objects with reference to FIG. 4, FIG. 5, FIG. 6, FIG. 7 and FIG. 8.

FIG. 4 is a flowchart illustrating a method of providing AR information using virtual objects according to an exemplary embodiment of the invention. More particularly, FIG. 4 illustrates a method for setting a virtual object.

Referring to FIG. 2, FIG. 3, and FIG. 4, the control unit 260 may drive the image acquisition unit 210 via the manipulation unit 230 to acquire a real-world image of a target location and may then display the real-world image of the target location on the display unit 220 (410). The real-world image of the target location may be a real-world image of the location of the terminal 110 or a real-world image of another location provided by the server 130. More specifically, the server 130 may provide the terminal 110 with real-world preview images. The real-world preview images may be provided by cameras installed at various public places or by a database storing the respective images.

Thereafter, the control unit 260 may set at least one virtual object to be included in the real-world image of the particular location (420). More specifically, if a request for setting virtual objects is received from the user, the terminal 100 may provide a ‘set virtual object’ menu screen.

The control unit 260 may upload the virtual object (set in operation 420) onto the real-world image of the target location (430). More specifically, the control unit 260 may superimpose or overlay the virtual object set in operation 420 on top of the real-world image displayed on the display unit 220 in response to the receipt of a signal for selecting the corresponding virtual object. For example, referring to FIG. 5A, one of the virtual objects included in the list 511 may be uploaded simply by being dragged and dropped at a location 512 is marked by “+.”

Thereafter, the control unit 260 may transmit virtual object setting information regarding the virtual object (set in operation 420) to the server 130 (440). Then, the control unit 340 of the server 130 may store the virtual object setting information in the virtual object storage unit 340, upload the virtual object set in operation 420, onto an image of the target location stored in the image storage unit 320, so that the virtual object is superimposed or overlaid on top of the target location image. Afterwards, the server 130 may transmit the combined image of the target location with the virtual object to other terminals.

FIG. 5A is a diagram illustrating an interface screen to set a path for a virtual object to move along according to an exemplary embodiment of the invention. More specifically, FIG. 5A illustrates a ‘set virtual object’ menu screen. FIG. 5B is a diagram illustrating an interface screen to set a path for a virtual object to move along according to an exemplary embodiment of the invention.

Referring to FIG. 5A, the ‘set virtual object’ menu screen may include a ‘select virtual objects’ item 510, a ‘movement mode’ item 520, and a ‘purpose of use’ item 530. Further, ‘additional setting mode’ item 540 may be optionally included.

If a signal to select the ‘select virtual objects’ item 510 is received, the terminal 110 may display a list 511 of one or more virtual objects on the display unit 220, and may then allow the user to select at least one of the virtual objects in the list 511. In addition, the user may register new virtual objects in the terminal 110 instead of choosing one or more of the virtual objects in the list 511.

The ‘movement mode’ item 520 may be provided for setting a travel path between at least two locations (i.e. a starting point and an ending point) for a virtual object to follow. If is the ‘movement mode’ item 520 is selected, a map of a region shown in the real-world image acquired by the image acquisition unit 210 may be provided as an interface screen, as shown in FIG. 5B.

Referring to FIG. 5B, one or more menu items 580 including ‘point of departure,’ ‘destination,’ path, ‘moving speed,’ and ‘time’ may be provided on the lower right side of the interface screen.

If the ‘point of departure’ item is selected with the aid of the manipulation unit 230, the control unit 260 may mark a point of departure on a map displayed on the interface screen. For example, if the user selects the ‘point of departure’ item and then clicks on a particular point 550 on the map, the point 550 may be set as a point of departure, and may be marked as ‘Start.’ Similarly, if the user selects the ‘destination’ item and clicks on another point 560 on the map, the point 560 may be set as a destination, and may be marked as ‘Destination.’ The control unit 260 may output a list of destinations, in addition to the list 511 of virtual objects, in order to meet the convenience of the user. If destination information is received from the user, the control unit 260 may determine whether a location corresponding to the destination information is a serviceable area. If the location corresponding to the destination information is an unserviceable area (e.g., remote location, mountain, ocean, desert, and the like), the control unit 260 may request the user to change the destination information.

However, if the destination location is a serviceable area, the control unit 260 may set a path between the departure point 550 and the destination 560. For example, referring to FIG. 5B, the control unit 260 may set a path between the departure point 550 and the destination 560 in response to a drag of a mouse cursor 570 from the departure point 550 to the destination 560. If no such path information is received, the control unit 260 may provide a default path, if any, from the departure point 550 to the destination 560. In an example, the default path may be determined based on a shortest distance algorithm, fastest route algorithm, or any other suitable algorithms. The control unit 260 may set moving speed information for a virtual object. The moving speed of a virtual object may be set to a default value or to a value entered by the user with the use of the manipulation unit 230. Once the movement setting of a virtual object is complete, the control unit 260 may display the location of the virtual object on a map in real time and may control the virtual object to move along the path set between the departure point 550 and the destination 560 at a reference speed.

Referring back to FIG. 5A, the ‘purpose of use’ item 530 may be provided to enter the purpose of use of a virtual object into the terminal 110. Examples of the purpose of use of a virtual object include, but are not limited to, advertising a product, participating in a virtual meeting, collecting data, searching for friends, and having a travel chat session. If the purpose of use of a virtual object is received, the control unit 260 may modify the virtual object or add additional information to the virtual object according to the purpose of use of the virtual object. For example, if the purpose of use is for advertisement of a product, the virtual object may have marketing logos on or around the virtual object. On the other hand, if the purpose of use is for a business meeting, the virtual object may be supplemented with a company logo, business attire, or a virtual business card. Further, selection of the ‘additional setting mode’ item may allow for the setting of additional features, saving or sharing information, language selection, and the like.

Also, although not illustrated, the menu screen may also allow the user to select a shape or shape information of a virtual object.

FIG. 6 is a flowchart illustrating a method of providing AR information using virtual objects according to an exemplary embodiment of the invention. More particularly, FIG. 6 illustrates how terminals can communicate with each other using virtual objects.

Referring to FIG. 6, a first terminal may drive its image acquisition unit via its manipulation unit to acquire a real-world image of a target location and may then display the real-world image of the target location on its display unit (610). In an example, the real-world image of the target location may be a real-world image corresponding to a location of the terminal 110 or a real-world image of another location provided by the server 130. More specifically, the server 130 may provide the first terminal with real-world preview images provided by cameras installed at various public places or by an image storage database. The real-world image of the target location may include at least one virtual object.

Thereafter, if a request to access to the virtual object in the real-world image of the target location or an access request is received via the manipulation unit of the first terminal (620), the first terminal may transmit a signal to request access to the virtual object in the real-world image of the target location to the server 130 (630).

Then, the server 130 may detect a second terminal that has registered the virtual object in the real-world image of the same target location (640), and may transmit a notification message to the second terminal, indicating that the first terminal is requesting access to the second terminal (650).

The second terminal may output an access request notification signal via its display unit or audio output unit upon the receipt of an access request from the first terminal, and may determine whether an access request acceptance signal is received from its user.

If an access request acceptance signal is received from the user of the second terminal (660), the second terminal may transmit an access request acceptance message to the first terminal via a wired or wireless communication network (670). Then, the first terminal and is the second terminal drive their service module (680) and communicate with each other (690).

FIG. 7 is a diagram illustrating a virtual object superimposed over a real-world image according to an exemplary embodiment of the invention.

Referring to FIG. 7, the virtual object 710, moving direction information 720 and destination information 730 of the virtual object 710 may be displayed over a real-world image in a superimposed manner. More specifically, the virtual information including virtual object 710, moving direction 720, and destination 730 are overlaid on to top of the real-world image to display a single image to a user. As a result, a single image with both virtual reality information and real-world image is provided.

FIG. 8 is a diagram illustrating a display screen that can be displayed during the communication between terminals using virtual objects according to an exemplary embodiment of the invention. More particularly, FIG. 8 illustrates a chat window 820 displayed on the display unit of a first terminal during a chat session between the first terminal and a second terminal.

Referring to FIG. 8, a real-world image of a target location may be displayed on the display screen as a background image, and a chat window 820 in which the users of the first terminal and the second terminal can exchange text messages is also displayed near the top on the display screen. Further, a virtual object 810 representing the second terminal and a message 830 indicating that the first terminal user and the second terminal user are engaged in a chat session may be displayed over the real-world image. Thus, any other terminal can easily identify whether the first terminal user and the second terminal user are having a chat session with each other upon the receipt of the real-world image of the target location.

As described above, it is possible to provide communication services to terminals is using virtual objects. In addition, it is possible for a user to engage in various events, through his or her virtual object, with other users that are encountered along the path of movement of his or her virtual object.

A number of examples have been described above. Nevertheless, it should be understood that various modifications may be made. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing augmented reality (AR) information using virtual objects, the method comprising:
receiving virtual object setting information by a first terminal, wherein the virtual object setting information comprises virtual object selection information and movement setting information; and
transmitting a request to a server for uploading a virtual object onto a real-world image of a target location based on the virtual object setting information.

2. The method of claim 1, wherein the virtual object setting information is received from a user.

3. The method of claim 1, further comprising receiving a selection of at least one virtual object to be uploaded onto the real-world image from a list of virtual objects.

4. The method of claim 1, wherein the movement setting information comprises at least one of destination information, path information, moving speed information and time setting information.

5. The method of claim 1, wherein the receiving of the virtual object setting information comprises receiving a purpose of use of the virtual object.

6. The method of claim 4, further comprising:
transmitting an access request signal to a second terminal to the server, wherein the second terminal has registered and uploaded a virtual object onto the same real-world image; and
communicating with the second terminal.

7. The method of claim 1, further comprising receiving the real-world image from the server.

8. The method of claim 1, further comprising obtaining the real-world image by the first terminal.

9. The method of claim 1, further comprising:
receiving an access request from a second terminal;
transmitting an access acceptance message to the second terminal; and
communicating with the second terminal.

10. The method of claim 1, wherein the real-world image is a real-time image.

11. A method for providing AR information using virtual objects, the method comprising:
receiving, by a server, a request signal for uploading a virtual object onto an real-world image of a target location from a terminal;
receiving virtual object setting information from the terminal; and
uploading a virtual object onto the real-world image based on the virtual object setting information.

12. The method of claim 11, wherein the virtual object setting information comprises at least one of a shape of the virtual object and a purpose of use of the virtual object.

13. The method of claim 12, wherein the virtual object setting information further comprises movement setting information, wherein the movement setting information comprises at least one of destination information, path information, moving speed information and time setting information.

14. The method of claim 11, further comprising:
receiving a request signal for obtaining the real-world image of the target location from the terminal;
retrieving the requested real-world image of the target location;
transmitting the real-world image to the terminal; and
detecting a virtual object associated with the target location in real-world for uploading onto the real-world image,
wherein the uploading of the virtual object comprises uploading the detected virtual object onto the real-world image and transmitting the real-world image with the detected virtual object updated thereonto to the terminal.

15. The method of claim 11, wherein the real-world image is a real-time image.

16. An apparatus to provide augmented reality (AR) information using virtual objects, comprising:
a communication unit to process signals received from a server and to transmit signals to the server, wherein the signals are transmitted and received using a wired and/or wireless communication network;
a display unit to display a real-world image of a target location;
a manipulation unit to receive a user input signal; and
a control unit to receive virtual object setting information and to request the server to upload a virtual object onto the real-world image of the target location, wherein the virtual object setting information comprises virtual object selection information and movement setting information.

17. The apparatus of claim 16, wherein the control unit receives virtual setting information via the manipulation unit.

18. The apparatus of claim 16, wherein the control unit receives a user selection of a virtual object from a list of virtual objects via the manipulation unit.

19. The apparatus of claim 16, wherein the movement setting information comprises at least one of destination information, path information, moving speed information and time setting information.

20. The apparatus of claim 19, wherein the control unit transmits to the server a signal to request access to a second terminal, wherein the second terminal comprises a registered virtual object uploaded onto the real-world image.

21. The apparatus of claim 16, wherein the control unit receives an access request from a second terminal to allow the user to decide whether to accept the access request.

22. The apparatus of claim 16, wherein the real-world image is received from the server.

23. The apparatus of claim 16, wherein the real-world image is a real-time image.

24. An apparatus to provide AR information using virtual objects, the apparatus comprising:
a communication unit to process signals received from a terminal or to transmit signals to the terminal, wherein the signals are transmitted or received using a wired and/or wireless communication network, and to receive virtual object setting information from the terminal;
a virtual object information storage unit to store the virtual object setting information; and
a control unit to receive a request signal to upload a virtual object onto a real-world image of a target location, and to control the virtual object information storage unit to store the virtual object setting information upon the receipt of the request signal.

25. The apparatus of claim 24, wherein the control unit determines whether the virtual object is selected to be uploaded onto a target location requested by the terminal, and to transmit the image of the target location if the virtual object is determined to be uploaded to the target location.

26. The apparatus of claim 24, wherein the real-world image is a real-time image.
